(19) United States
(12) Patent Application Publication
(10) Pub. No.: US 2008/0033862 A1
(43) Pub. Date: Feb. 7, 2008

(54) Business Method For Last Minute Sales

(76) Inventor: Mohammad R. Ehsani, Tucson, AZ (US)

Correspondence Address: QUICKPATENTS, INC., 32861 CALLE PERFECTO, SUITE A, SAN JUAN CAPISTRANO, CA, 92675, US

(21) Appl. No.: 11/470,727

(22) Filed: Sep. 7, 2006

Related U.S. Application Data
(60) Provisional application No. 60/830,714, filed on Jul. 14, 2006.

(51) Int. Cl. G06Q 40/00

(52) U.S. Cl. 705/37

(57) ABSTRACT

Disclosed is a method of selling expiring commodities to customers via a wide-area computer network such as the Internet, wireless phone networks, or the like. A computer system implements the steps of the method of the present invention, and provides for establishing in a database a commodity record representing a commodity for sale. Such a commodity record includes at least an expiration time, a price, information about the seller, and a quantity of such commodities that are available for sale. Once the database is loaded with commodities that are available for sale, customers may link to the system through the communications network to search for suitable commodities. Upon adequate search query information being submitted to the system, the database is searched for commodities that match. The system may then check all commodities in the database, or check just those commodities that match the customer's search query, to be sure such commodities have not expired. Commodities that match the customer's search query and that have not expired are then displayed to the customer, and the customer then has the option of selecting one or more of such commodities for purchase. Commodities that have expired are removed from the database. Preferred commodities sold with the method of the present invention include hotel rooms, event tickets, travel tickets, and other commodities with a fixed expiration date and time.

### CROSS-REFERENCE TO RELATED APPLICATIONS

This application claims the benefit of U.S. Provisional Patent Application 60/830,714, filed on Jul. 31, 2006.

### STATEMENT REGARDING FEDERALLY SPONSORED RESEARCH AND DEVELOPMENT

Not Applicable.

### FIELD OF THE INVENTION

This invention relates to a method of selling commodities, and more particularly to a method of selling time-sensitive commodities.

### DISCUSSION OF RELATED ART

Computer implemented systems for selling commodities are well known in the prior art. For example, travel sites, hotel reservation sites, and the like typically sell commodities such as hotel rooms, travel tickets and event tickets. However, such prior art computer systems and methods are not well-suited for use in selling commodities that are imminently perishable, such as those expiring within the next six to twenty-four hours. Moreover, such systems do not include means for incrementally decreasing the price of the commodity to a minimum price upon expiration. When a business, such as a hotel, recognizes that it has excess inventory of a soon-to-be expiring commodity, such a business cannot rely upon existing prior-art systems to quickly make available such commodities for discounted purchase, nor provide an easy-to-use interface for consumers to easily ascertain the availability of such commodities.

U.S. Pat. No. 6,671,676 to Shacham on Dec. 30, 2003, teaches a system for selling time-variable resources that expire, but is directed more towards the sale of products such as perishable foods, advertising time, and the like. Such a system is not well-suited for the sale of expiring commodities such as hotel rooms, wherein a potential customer is in the vicinity of the hotel and wishes to reserve the hotel immediately, on-line or over a wireless network. All such prior art systems necessarily require typically a few days to effect the sale and deliver the proper paperwork to the customer and seller. But there is no prior art system that is useful for last-hour or last-minute sales.

On-line hotel reservation sites such as Hotels.com and Expedia.com typically purchase blocks of rooms from hotels at wholesale in advance, and then offer them to the public via their website at a relatively slight discount such as 10% to 15% off of the regular price. Such systems allow the consumer to reserve rooms for multiple nights months and weeks in advance. However, such systems are not well-suited for quick sales of suddenly available and soon-to-be expiring rooms, which may easily be discounted 40%-50%, one night at a time and for the same day that the rooms are known to be available. Even with such prior-art business methods in place, and others such as PriceLine.com, a large number of hotel rooms go unsold each night. Such systems are not well-suited for daily direct interaction with sellers and buyers for making available such expiring commodities.

Therefore, there is a need for an easy-to-use system that sellers can use, most likely daily, to indicate the availability of rapidly-expiring commodities, and in which consumers may utilize to identify suitable such commodities and purchase immediately. Such a needed system would check the expiration dates on such commodities before display search results to potential customers, and would further have the ability to decrease the price of such commodities to a minimum selling price established by the seller as the current time approaches the expiration time. The present invention accomplishes these objectives.

### SUMMARY OF THE INVENTION

The present device is a method of selling expiring commodities to customers via a wide-area computer network such as the Internet, wireless phone networks, or the like. A computer system implements the steps of the method of the present invention. In a basic implementation of the method of the present invention, the system provides for establishing in a database a commodity record representing a commodity for sale. Such a commodity record includes at least an expiration time, a price, information about the seller, and a quantity of such commodities that are available for sale. In the case where the commodity is hotel room rentals, the expiration time is preferably six to twelve hours after the seller has established the commodity in the database. In the case where the commodity is an event ticket, such as a concert ticket or play or other performance ticket, or in the case where the commodity is travel tickets such as reservations for a cruise or an airline flight that is departing at a specific date and time, preferably the expiration time is within twenty-four hours after the seller has established the commodity in the database.

Once the database is loaded with commodities that are available for sale, customers may link to the system through the communications network to search for suitable commodities. Upon adequate search query information being submitted to the system, the database is searched for commodities that match. The system may then check all commodities in the database, or check just those commodities that match the customer's search query, to be sure such commodities have not expired. Commodities that match the customer's search query and that have not expired are then displayed to the customer, and the customer then has the option of selecting one or more of such commodities for purchase.

Purchasing of the commodities is performed in any number of ways common in the prior art, via an Internet check-out process, being connected to a customer service representative, or the like. Upon completion of the purchasing of the at least one commodity by the customer the seller is notified of the sale of the at least one commodity, customer identification information, the date and time of the sale, and any additional information necessary for the seller to either reserve or complete the sale of the commodity. Further, upon completion of a sale, the system decrements the available quantity of the commodity that is available for sale in the database, or, if the available quantity is now zero, removes the commodity record from the database altogether.

In one embodiment of the invention, each commodity record may further include a starting price and a minimum price, wherein the system decreases the price from the starting price to the minimum price between the time that the commodity is entered into the database and the expiration time of the commodity. The starting price and minimum price are established by the seller, and the price may either decrease linearly, in a step-wise progression to the nearest whole dollar or the nearest five dollar increment, for example, or following some other function.

The present invention is an easy-to-use method implemented by a system that sellers can use to indicate the availability of rapidly-expiring commodities, and in which consumers may utilize to identify suitable such commodities and purchase immediately. Such available commodities, such as hotel rooms, can be posted daily and be limited to being sold only on the day that they expire, thereby not competing with other systems that allow for reservations far in advance at a higher price. The present invention checks the expiration dates on such commodities before displaying search results to potential customers, and further has the ability to decrease the price of such commodities to a minimum selling price established by the seller as the current time approaches the expiration time. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a diagram illustrating a system for matching buyers and sellers of expiring commodities;

FIG. 2A is a flow diagram illustrating an approach for a seller to update a database of expiring commodities for sale;

FIG. 2B is a flow diagram illustrating an approach for a seller to update a database of expiring commodities for sale upon logging into a computer system of the invention;

FIG. 3 is a flow diagram illustrating a method of removing commodities from the database that have expired; and

FIG. 4 is a flow diagram illustrating a method wherein a customer may search for a desired commodity and purchase same.

### DETAILED DESCRIPTION OF THE PREFERRED EMBODIMENT

In the following description, specific details are illustrated to provide a thorough understanding of the invention. However, anyone skilled in the art may practice this invention without using such specific details, instead relying on the claims and common practices known in the art. Further, block diagrams used may represent well-known methods or structures and may not be explained in detail, so as to avoid unnecessarily complicating the present disclosure. As used herein, the term “commodity” refers to any good or service that expires after a certain time or date, such as a hotel room rental for a particular night, an entertainment or event ticket, a transportation ticket, and the like. Once expired, such a commodity becomes worthless and should not be made available for sale.

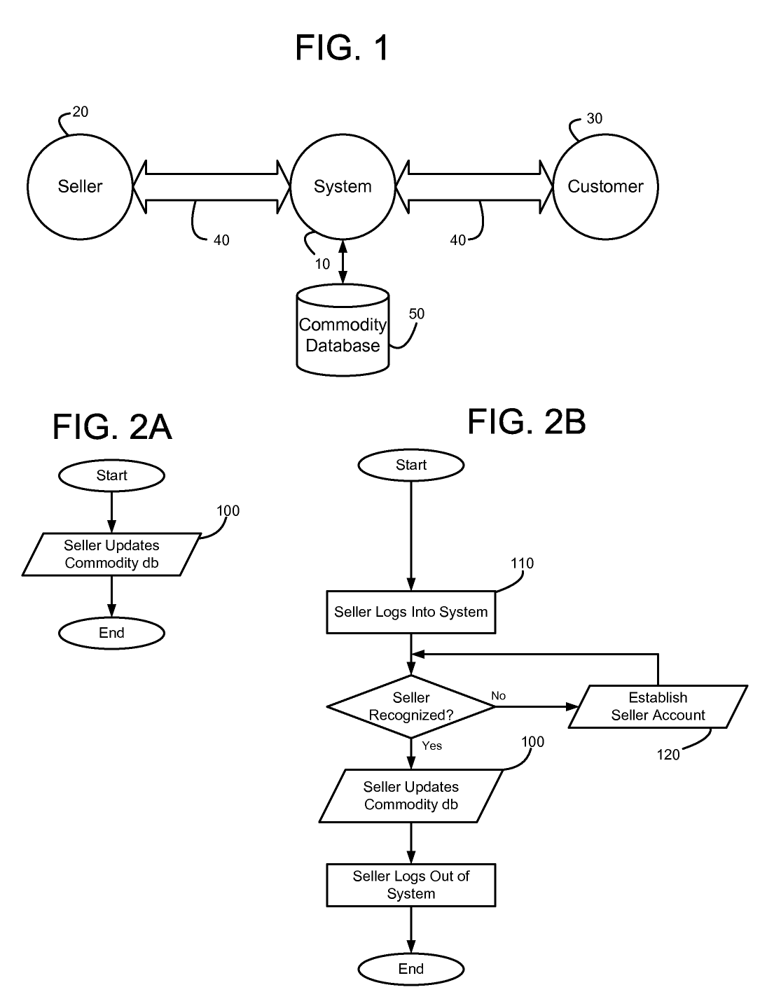

FIG. 1 is a block diagram generally illustrating the structure used to implement the method of the present invention, wherein a seller 20 and a customer 30 are matched via a computer system 10, the seller 20 and the customer 30 both having connectivity to preferably a communications network 40 such as the Internet, a telephone network, a text messaging network, a wireless network or the like. The computer system 10 implements the steps of the method of the present invention, the means by which soon-to-be expiring commodities may be sold to the customer 30 by the seller 20.

In a basic implementation of the method of the present invention, the system 10 provides an establishment step 100 for establishing in a database 50 a commodity record representing a commodity for sale. Such a commodity record includes at least an expiration time, a price, information about the seller 20, and a quantity of such commodities that are available for sale. By way of example, such a commodity may be the rental of a hotel room for a particular day. As such, the commodity record in the database 50 for such a hotel room rental would include the date and time that the commodity expires, a price that the seller 20 is offering for the commodity, a seller identification number or other seller identifying information, and a quantity of rooms that are available. FIG. 2A illustrates a flow diagram depicting, in the most basic mode of the invention, how the seller 20 updates commodity records for those commodities in the database 50 that the seller 20 is offering.

In the case where the commodity is hotel room rentals, the expiration time is preferably six to twelve hours after the seller 20 has established the commodity in the database 50. In the case where the commodity is an event ticket, such as a concert ticket or play or other performance ticket, or in the case where the commodity is travel tickets such as reservations for a cruise or an airline flight that is departing at a specific date and time, preferably the expiration time is within twenty-four hours after the seller 20 has established the commodity in the database 50.

Preferably, however, such a system 10 includes a seller login approach, as depicted in FIG. 2B, wherein the seller 20 must first perform a login step 110 to login to the system 10, most likely from a remote location, and be recognized as an established seller in the system 10. If the seller 20 is not recognized, the seller 20 is allowed to establish an account with the system 10 at an account establishment step 120. Once a seller 20 is recognized by the system 10, the seller's physical location being a required data field for a seller record of the seller 20, the system 10 may link such seller information to each commodity that the seller 20 makes available for sale by the system 10. For example, the system 10 may use the seller's location information in the seller's information record in order to provide seller's proximity to the customer 30 as a criteria for customer queries for available commodities, for example. Further, the seller 20 itself may be one of the search criteria, since customers 30 may prefer certain sellers 20 over others.

Once the database 50 is loaded with commodities that are available for sale at the establishment step 100, customers 30 may link to the system 10 through the communications network 40 to search for suitable commodities (FIG. 4). Again using the example of hotel rooms, the customer 30 may enter search criteria such as the customer's location, such as by zip code, city, street address, or the like, in a criteria input step 130. If a customer 30 is using a GPS enabled computer or device (not shown), or a wireless phone on a network with location triangulation capabilities, such position information may be in the form of longitude and latitude, and may be delivered by the customer's computer device itself transparently to the customer 30. Additional criteria that may be entered by the customer 30 may include criteria such as maximum distance away from the customer's current location, a maximum acceptable price, type of hotel room, whether the room is designated as a smoking or a non-smoking room, and the like.

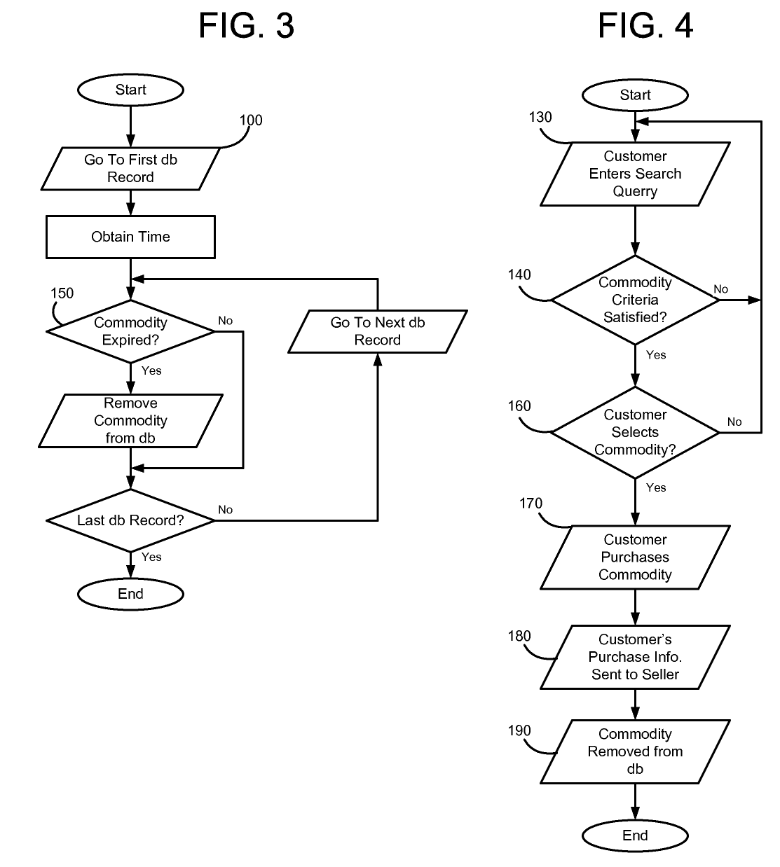

Once adequate search query information has been submitted to the system 10, the database 50 is searched at a search step 140 for commodities that match. Optionally, as illustrated in FIG. 3, at this point the system 10 may perform an expiration check step 150 to check all commodities in the database 50, or check just those commodities that match the customer's search query, to be sure such commodities have not expired. In an alternate embodiment of the invention, such a check for expiration of commodities may be performed at regular intervals, such as every five minutes.

Commodities that match the customer's search query and that have not expired are then displayed to the customer 30, and the customer 30 then has the option of selecting one or more of such commodities for purchase in a selection step 160. Purchasing of the commodities is performed in any number of ways common in the prior art in a purchasing step 170, via an Internet check-out process, being connected to a customer service representative, or the like. Upon completion of the purchasing of the at least one commodity by the customer 30 the seller 20 is notified in a notification step 180 of the sale of the at least one commodity, customer 30 identification information, the date and time of the sale, and any additional information necessary for the seller to either reserve or complete the sale of the commodity. In the case hotel rooms, for example, the seller 20 is notified of the customer's identity, payment information, the type of room that the customer 30 has reserved or rented, and the like.

Further, upon completion of a sale, the system 10 decrements in a database update step 190 the available quantity of the commodity that is available for sale in the database 50, or, if the available quantity is now zero, removes the commodity record from the database 50 altogether.

In one embodiment of the invention, each commodity record may further include a starting price and a minimum price, wherein the system 10 decreases the price from the starting price to the minimum price between the time that the commodity is entered into the database 50 and the expiration time of the commodity. For example, a hotel room rental set-up at 8:00 pm one night may decrease in price from, say, $100 to $60 over the course of eight hours, whereupon the commodity expires at 4:00 am the next morning. As such, in the given example, at midnight the price of the hotel room may be $80. The starting price and minimum price are established by the seller 30, and the price may either decrease linearly, in a step-wise progression to the nearest whole dollar or the nearest five dollar increment, for example, or following some other function.

While a particular form of the invention has been illustrated and described, it will be apparent that various modifications can be made without departing from the spirit and scope of the invention. For example, the means by which the system transfers customer purchase information to the seller may be by XML, fax, email, EDI, or whatever means desired by the seller to most quickly update the seller's business systems, such as inventory or reservation computer systems. Accordingly, it is not intended that the invention be limited, except as by the appended claims.

What is claimed is:

1. A method of selling commodities to customers, the method comprising the computer-implemented steps of:
a.) defining in a database a commodity for sale and designating at least an expiration time, a price, a seller, and a quantity;
b) providing to a potential customer a searching and displaying means of the database for the available commodities that have not expired;
c) allowing the customer to select and purchase at least one of the commodities;
d) decrementing the at least one sold commodity from the database; and
e) transmitting information about the customer's purchase to the seller.

2. The method of claim 1 wherein the expiration time is within twenty-four hours of the completion of step a).

3. The method of claim 1 wherein the expiration time is within twelve hours of the completion of step a).

4. The method of claim 1 wherein the expiration time is within six hours of the completion of step a).

5. The method of claim 1 wherein the commodities are hotel rooms.

6. The method of claim 1 wherein the commodities are event tickets.

7. The method of claim 1 wherein the commodities are cruise tickets.

8. The method of claim 1 wherein the commodities are transportation tickets.

9. The method of claim 1 wherein step a) comprises the steps of:
a1) the seller logging into the database remotely via a wide area network;
a2) the seller defining in the database a commodity for sale and designating at least an expiration time, a price, and a quantity of the commodity available; and
a3) a computer defining in the database the seller for the commodity based on seller login information, and the time that the commodity was defined.

10. The method of claim 9 wherein step a2) is the seller defining in the database a commodity for sale and designating at least an expiration time, a starting price, a minimum ending price, and a quantity of the commodity available; and wherein step 4) is providing to a potential customer a searching means of the database for the available commodities that have not expired, the searching means displaying to the potential customer a displayed price between the starting price and the minimum ending price, the displayed price being a function of the starting price, the ending price, the current time, the time that the commodity was defined, and the expiration time.

11. The method of claim 1 wherein step b) is allowing a potential customer to enter at least one search parameter into a searching and displaying means of the database for the available commodities that have not expired that match the at least one parameter.

12. The method of claim 11 wherein one of the search parameters is a geographic location parameter and another of the search parameters is an acceptable distance parameter, whereby the displaying means displays available commodities that have not expired and that are within the acceptable distance of the geographic location parameter.

13. The method of claim 12 wherein the geographic location parameter is a US Zip Code.

14. The method of claim 12 wherein the geographic location parameter is a street address.

15. The method of claim 12 wherein the geographic location parameter comprises longitude and latitude data transmitted to the computer by a location-aware computer of the potential customer.

16. The method of claim 1 wherein step e) is transmitting information about the customer's purchase to the seller via a wide area network.
